(19) United States
(12) Patent Application Publication
(10) Pub. No.: US 2006/0232383 A1
(43) Pub. Date: Oct. 19, 2006

(54) RFID tag and RFID reader for anti-collision and operating method thereof

(75) Inventors: Hyung-min Yoon, Seoul (KR); Woo-shik Kang, Suwon-si (KR); Si-gyoung Koo, Seoul (KR); Ji-hun Koo, Yongin-si (KR); Kyung-ho Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/378,355

(22) Filed: Mar. 20, 2006

(30) Foreign Application Priority Data
Apr. 15, 2005 (KR) 2005-31465

(51) Int. Cl. H04Q 5/22

(52) U.S. Cl. 340/10.2

(57) ABSTRACT

A radio frequency identification (RFID) tag and a RFID reader for anti-collision, and an operation method thereof are provided. The RFID tag includes a tag receiving part for receiving a tag recognition signal from a RFID reader, a tag transmitting part for transmitting a response signal and a tag data in response to the tag recognition signal, a mode switching part for switching current mode into a predetermined mode, and a controlling part for causing the predetermined mode to be switched by the mode switching part, when the response signal is transmitted by a predetermined number of times by the tag transmitting part. Accordingly, when a few number of RFID tags are used, collision of tag data can be prevented at the RFID reader, and the RFID tags are rapidly recognized.

### CROSS-REFERENCE TO RELATED APPLICATIONS

This application claims priority from Korean Patent Application No. 2005-31465, filed Apr. 15, 2005, in the Korean Intellectual Property Office, the disclosure of which is incorporated herein by reference.

### BACKGROUND OF THE INVENTION

1. Field of the Invention

The present invention relates to a RFID (radio frequency identification) tag and a RFID reader with anti-collision function, and an operating method thereof. More particularly, the present invention relates to a RFID reader and a RFID tag for preventing collision between RFID tags in the situation where the number of RFID tags are few in number, and an operating method thereof.

2. Description of the Related Art

A RFID (radio frequency identification) is one of the AIDC (Automatic identification and data capture) technologies, which contactlessly reads the data of the chip with a built-in microchip by using wireless frequency.

Basically, a RFID system includes a RFID tag which is attached to an object, and a transceiver to wirelessly transmit and receive information with the RFID tag. The RFID tag includes a microchip which stores identification code and information about the object, and an antenna to wirelessly transmit and receive information with the RFID reader. The transceiver has a reader to read out information stored in the RFID tag. The transceiver receives information from the RFID tag and transmits the information to the computer, and receives information from the computer and sends the information to the RFID tag.

When compared with the bar code, the identification technology which is currently widely used, the RFID system can hold far more information, and additionally, information can be transmitted between the RFID tag and the transceiver without requiring contact of the reader and the object with the RFID tag attached thereon.

However, the RFID system exhibits a problem with collision between the tags, especially when there are a plurality of RFID tags within a transmission range where the RFID reader can recognize the RFID tag, and thus, all the tags respond to the signal of the RFID reader.

A variety of anti-collision algorithms have been suggested to overcome the above problem. One of them suggests that a RFID tag transmit a preamble, a header and an RTT (Radio Transmission Technology) signal first, such that the RFID reader can selectively allow data transmission only for the RFID tags which succeed the transmission of preamble, header and RTT (Radio Transmission Technology) signal. Another suggests that a plurality of RFID tags respond during different random time intervals.

However, trends are such that number of RFID devices such as mobile devices increases and only one or a few number of RFID tags are used in many cases. If the above-mentioned suggestions are applied in these devices, the idling time of the RFID tags increases which is quite inefficient especially when the number of RFID tags being used are few.

### SUMMARY OF THE INVENTION

Accordingly, the present invention has been made to solve the above-mentioned problems, and an aspect of the present invention concept is to provide a RFID tag and a RFID reader for anti-collision of RFID tags in which a RFID reader rapidly recognizes RFID tags, especially when there are a few number of RFID tags being used, and an operating method thereof.

In order to achieve the above aspects and/or other features of the present invention, a RFID (radio frequency identification) tag for anti-collision is provided, including a tag receiving part for receiving a tag recognition signal from a RFID (radio frequency identification) reader, a tag transmitting part for transmitting a response signal and tag data in response to the tag recognition signal, a mode switching part for switching current mode into a predetermined mode, and a controlling part for causing the predetermined mode to be switched by the mode switching part, when the response signal is transmitted by a predetermined number of times by the tag transmitting part.

The predetermined mode switched by the mode switching part comprises one of a normal mode, a standby mode, a sleep mode and a dead mode.

The controlling part may control such that the current mode is switched into the standby mode by the mode switching part, when the response signal is transmitted a predetermined number of times.

The controlling part may control such that the current mode is switched into the sleep mode by the mode switching part, when the mode switch signal relating to itself is transmitted from the RFID reader through the tag transmitting part.

According to an aspect of the present invention, an operating method of a RFID (radio frequency identification) tag for anti-collision, comprises: receiving a tag recognition signal from a RFID (radio frequency identification) reader; transmitting a response signal and tag data in response to the tag recognition signal, and switching a current mode to a predetermined mode, when the response signal is transmitted a predetermined number of times.

The mode for switching comprises one of a normal mode, a standby mode, a sleep mode and a dead mode.

The step of switching the current mode into the sleep mode may be further provided, when a mode switch signal relating to itself is transmitted from the RFID reader.

According to another aspect of the present invention, a RFID (radio frequency identification) reader for anti-collision can be provided, including a reader transmitting part for transmitting a tag recognition signal to one or more RFID tags, a reader receiving part for receiving tag data from the RFID tags in accordance with the tag recognition signal, and a controlling part for, when the tag data is received, generating a mode switch signal for a RFID tag corresponding to the received tag data and transmitting through the reader transmitting part.

When the reception of the tag data fails, the controlling part may control such that the tag data is re-received through the reader receiving part.

The mode switch signal generated by the controlling part comprises a signal to switch the RFID tag into sleep mode.

The controlling part may control the reader transmitting part to re-retransmit the tag recognition signal, after the mode switch signal is transmitted through the reader transmitting part.

According to yet another aspect of the present invention, an operation method of a RFID (radio frequency identification) reader for anti-collision may be provided, comprising transmitting a tag recognition signal to one or more RFID tags, receiving tag data from the RFID tags in accordance with the tag recognition signal, and when the tag data is received, generating a mode switch signal for a RFID tag corresponding to the received tag data and transmitting through the reader transmitting part.

When the reception of the tag data fails in the step of receiving the tag data, the step of re-receiving the tag data may be provided.

The generated mode switch signal comprises a signal to switch the RFID tag into sleep mode.

The step of re-transmitting the tag recognition signal may be further provided, after the mode switch signal is transmitted.

### BRIEF DESCRIPTION OF THE DRAWINGS

The above aspects and features of the present invention will be more apparent by describing certain exemplary embodiments of the present invention with reference to the accompanying drawings, in which:

FIG. 1 is a block diagram of a RFID reader for anti-collision according to an exemplary embodiment of the present invention;

FIG. 2 is a block diagram of a RFID tag for anti-collision according to an exemplary embodiment of the present invention;

FIG. 3 is a flowchart provided for explaining an operation method of a RFID reader for anti-collision according to an exemplary embodiment of the present invention;

FIG. 4 is a flowchart provided for explaining an operation of a RFID tag for anti-collision according to an exemplary embodiment of the present invention; and

FIGS. 5A and 5B are graphs provided for explaining time consumption required for the RFID reader to recognize a RFID tag within a predetermined time according to an exemplary embodiment of the present invention.

### DETAILED DESCRIPTION OF THE EXEMPLARY EMBODIMENTS

Certain exemplary embodiments of the present invention will be described in greater detail with reference to the accompanying drawings.

In the following description, same drawing reference numerals are used for the same elements even in different drawings. The matters defined in the description such as the detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

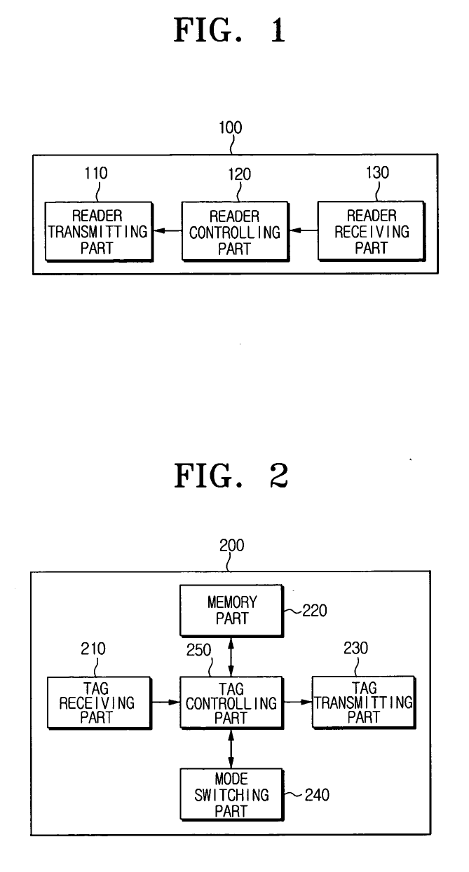

FIG. 1 is a block diagram of a RFID reader for anti-collision according to an exemplary embodiment of the present invention.

Referring to FIG. 1, a RFID reader 100 according to an exemplary embodiment of the present invention includes a reader transmitting part 110, a reader controlling part 120 and a reader receiving part 130.

The RFID reader 100 continuously emits frequencies using an antenna (not shown). The frequency radiated from the RFID reader 100 is received in at one or more RFID tags within a radiation range.

According to this exemplary embodiment of the present invention, the RFID reader 100 may be attached to wireless terminal devices such as mobile phone and PDA (Personal Digital Assistant), and changeable in position.

The reader transmitting part 110 transmits a tag recognition signal to one or more RFID tags under the control of the reader controlling part 120. The tag recognition signal may include a request for a unique ID of the RFID tag. For example, in this embodiment, there may be provided one to ten RFID tags.

The reader controlling part 120 controls overall functions of the RFID reader 100, and in order to perform the function of the RFID reader 100 for anti-collision according to the present invention, control signal input and output between the reader transmitting part 110 and a reader receiving part 130 which will be described below.

When tag data is received through the reader receiving part 130, the reader controlling part 120 controls such that a mode switch signal is generated for the RFID tag which corresponds to the received tag data, and the generated mode switch signal is transmitted through the reader transmitting part 110. The mode switch signal, being generated by the reader controlling part 120, relates to a signal which switches the RFID tag to a sleep mode.

When tag data reception through the reader receiving part 130 fails, the reader controlling part 120 controls the reader receiving part 130 to re-receive the tag data from the RFID tag.

The reader controlling part 120 controls the reader transmitting part 110 to re-transmit the tag recognition signal so that the RFID tag can be re-recognized after transmission of the mode switch signal through the reader transmitting part 110.

The reader receiving part 130 receives tag data from the RFID tag which is transmitted in accordance with the tag recognition signal transmitted from the reader transmitting part 110 to the RFID tag, and provides the received tag data to the reader controlling part 120.

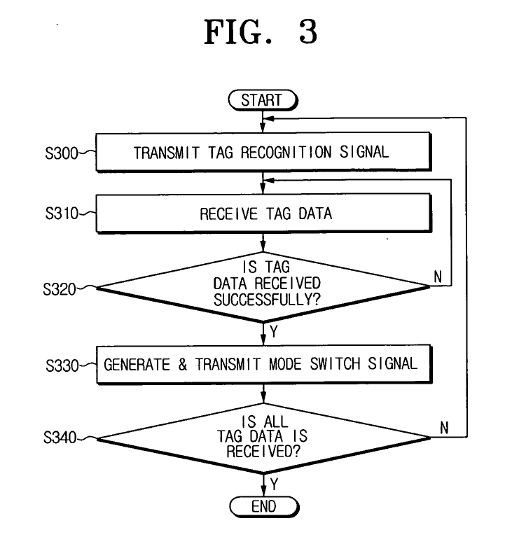

FIG. 2 is a block diagram of a RFID tag for anti-collision according to an exemplary embodiment of the present invention.

Referring to FIG. 2, a RFID tag 200 for anti-collision according to an exemplary embodiment of the present invention includes a tag receiving part 210, a memory part 220, a tag transmitting part 230, a mode switching part 240 and a tag controlling part 250.

The RFID tag 200 is attachable to a variety of objects and changeable in positions. When being placed within a frequency radiation range of the RFID reader 100, the RFID tag 200 can receive frequency from the RFID reader 100.

The tag receiving part 210 receives a tag recognition signal from the RFID reader 100, and provides the received tag recognition signal to the controlling part 250 which will be described in detail below.

The memory part 220 stores the tag data. The tag data stored in the memory part 220 is extracted by the tag controlling part 250 and transmitted to the RFID reader 100 via the tag transmitting part 230.

Under the control of the tag controlling part 250, the tag transmitting part 230 transmits a response signal and tag data to the RFID reader 100 in response to the tag recognition signal received through the tag receiving part 210. The tag data refers to the data stored in the memory part 220, and it may be extracted from the memory part 220 by the tag controlling part 250.

The mode switching part 240 switches current mode of the RFID tag 200 to a predetermined mode according to the control of the tag controlling part 250. The RFID tag mode may include normal mode, standby mode, sleep mode and dead mode, and the RFID tag can switch among the modes.

The tag controlling part 250 controls overall function of the RFID tag 200, and controls signal input and output between the tag receiving part 210, the memory part 220, the tag transmitting part 230 and the mode switching part 240.

When the response signal is transmitted from the tag transmitting part 230 for more than a predetermined number of times, the tag controlling part 250 controls the mode switching part 240 to switch modes. At this time, the tag controlling part 250 may control such that the RFID tag is switched into standby mode by the mode switching part 240.

According to one embodiment of the present invention, a plurality of RFID tags 200 are each preset with a different maximum number of transmissions for response signal. The maximum number of transmissions may be based on the unique ID region of the RFID tags 200, or may be based on random numbers as provided.

When the mode switch signal is transmitted from the RFID reader 100 through the tag receiving part 210, the tag controlling part 250 determines whether the received mode switch signal is directed to itself. If so, the tag controlling part 250 controls such that the current mode can be switched into sleep mode by the mode switching part 240.

It is now assumed that there are A, B and C RFID tags 200 within the transmission range of the RFID reader 100, and the process of RFID tags 200 responding to the signal of the RFID reader 100 will be explained below.

First, it is assumed that the A tag is set with ‘1’ time as the maximum number of response signal transmissions, the B tag is set with ‘2’, and the C tag is set with ‘3’ times.

All the RFID tags 200, that is, A, B and C tags within the transmission range of the RFID reader 100 receive the tag recognition signal from the reader transmitting part 110 of the RFID reader 100.

In response to the tag recognition signal received from the RFID reader 100, the A to C tags transmit response signals and their own tag data to the RFID reader 100 via the respective tag transmitting parts 230. Accordingly, three response signals are inputted to the RFID reader 100, colliding with each other. As a result, reception of tag data fails.

The A tag, having ‘1’ time as the maximum number of transmissions, responds to the tag recognition signal of the RFID reader 100 once, and switches to the standby mode.

Because one attempt to read in tag data has failed, the RFID reader 100 tries to re-receive the tag data through the reader receiving part 130. At this situation, A tag does not respond as it is on standby mode, but B and C tags respond.

However, since both of the B and C tags transmit response signal and tag data at the same time, collision occurs again, and thus, the RFID reader 100 fails to read in tag data.

The B tag, having ‘2’ times as the maximum number of transmissions, response twice to the tag recognition signal of the RFID reader 100, and then switches to the standby mode.

Because two attempts to read in tag data have failed, the RFID reader 100 tries to re-receive tag data through the reader receiving part 130. At this time, the B tag, being on standby mode, does not respond, but only the C tag responds. Therefore, the response signal and tag data of the C tag, which are transmitted through the tag transmitting part 230 of the C tag, are successfully received at the RFID reader 100.

The C tag, having ‘3’ times of maximum number of transmissions, responds three times to the tag recognition signal of the RFID reader 100, and switches to the standby mode. However, as the RFID reader 100, having successfully received tag data from the C tag, transmits a mode switch signal to the C tag, which switches into sleep mode.

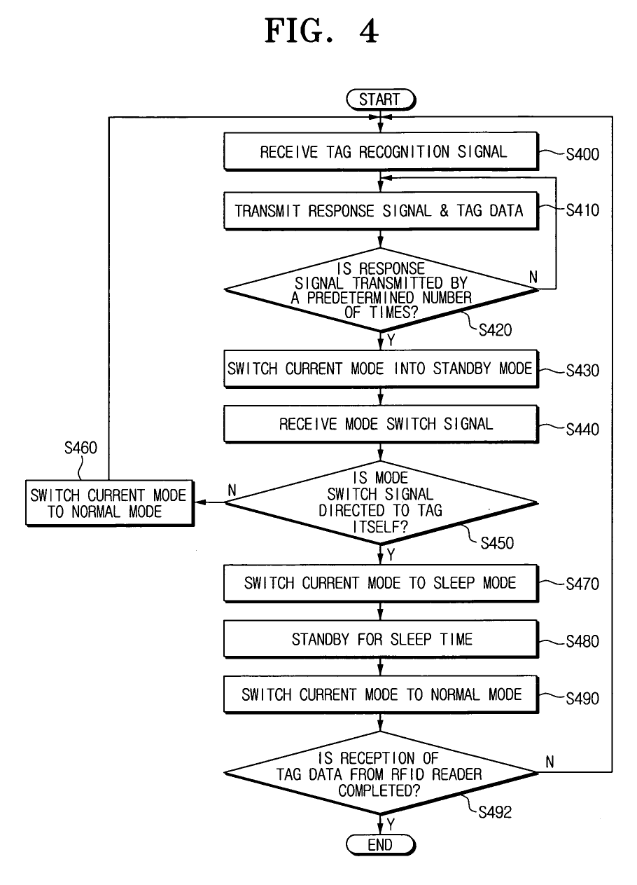

FIG. 3 is a flowchart provided for explaining the operation method of the RFID reader for anti-collision according to an exemplary embodiment of the present invention.

The operation method of the RFID reader 100 for anti-collision according to this exemplary embodiment of the present invention will be described with reference to FIGS. 1 to 3.

The reader transmitting part 110 of the RFID reader 100 transmits a tag recognition signal to allow recognition of the RFID reader 100 (S300). The tag recognition signal, being transmitted from the RFID reader 100, is transmitted to all of the RFID tags 200 located within the transmission range of the RFID reader 100.

When the tag recognition signal is received at the RFID tags 200 through the reader transmitting part 110, the RFID tags 200 transmit their own tag data to the RFID reader 100. The reader transmitting part 110 receives the tag data from the RFID tags 200 (S310).

As a plurality of RFID tags 200 transmit the tag data at the same time in response to the tag recognition signal, collision occurs. Accordingly, the reader controlling part 120 determines whether the tag data is received successfully or not (S320).

If it is determined in S320 that tag data from the plurality of RFID tags 200 does not collide, and thus, the tag data is received successfully, a mode switch signal is generated to switch the current mode of the RFID tags 200 into sleep mode. The reader controlling part 120 controls such that the generated mode switch signal is transmitted through the reader transmitting part 110, and therefore, the reader transmitting part 110 transmits the mode switch signal to the RFID tags 200 (S330).

At S320, if it is determined that transmission of tag data is not successful, the reader controlling part 120 controls such that the tag data can be re-received through the reader receiving part 130 (S310).

When the mode switch signal is transmitted through the reader transmitting part 110, the reader controlling part 120 determines whether all the tag data is received (S340). If not, the reader controlling part 120 controls such that the tag recognition signal is re-transmitted through the reader transmitting part 110. Then, the steps from S300 are repeated.

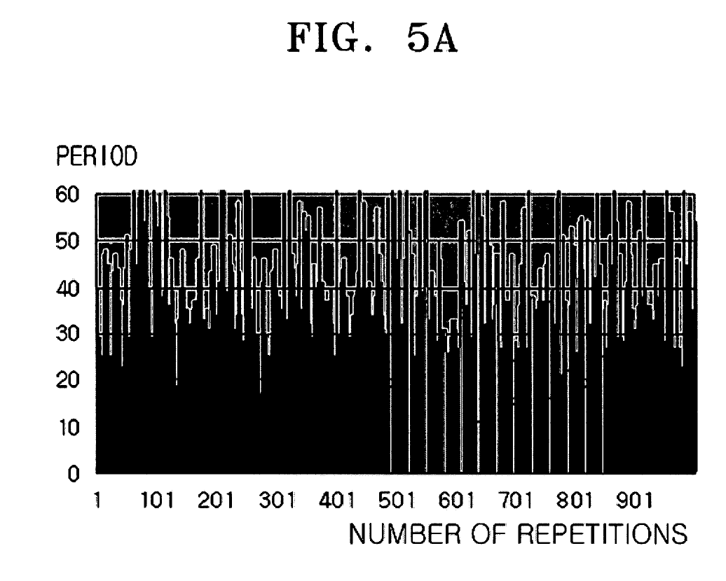

FIG. 4 is a flowchart illustrating the operation method of a RFID tag for anti-collision according to an exemplary embodiment of the present invention.

The operation method of a RFID tag for anti-collision according to this exemplary embodiment of the present invention will now be explained below with reference to FIGS. 1 to 4.

The tag receiving part 210 of the RFID tag 200 receives a tag recognition signal from the RFID reader 100, and provides the received tag recognition signal to the tag controlling part 250 (S400).

When the tag recognition signal is received, the tag controlling part 250 controls the tag transmitting part 230 to transmit a response signal and tag data in response to the tag recognition signal. The tag transmitting part 230 transmits the response signal and the tag data to the RFID reader 100 (S410).

Because the RFID reader 100 receives tag data from a plurality of RFID tags 200, collision may occur between the tag data. When the reception of tag data fails due to collision at the RFID reader 100, RFID tags 200 re-transmit the response signal and the tag data. The tag controlling part 250 determines whether the response signal is transmitted a predetermined number of times (S420).

When the response signal is determined to have been transmitted by the predetermined number of times at S420, the tag controlling part 250 controls the mode switching part 240 to switch the current mode of the RFID tag 200 to standby mode. Accordingly, the RFID tag 200 is switched into standby mode by the mode switching part 240 (S430).

When the mode switch signal is received from the RFID reader 100 via the tag receiving part 210 (S440), the tag controlling part 250 determines whether the received mode switch signal is directed to itself (S450).

If it determines that the received mode switch signal is not directed to itself at S450, the tag controlling part 250 controls such that the current mode can be switched to normal mode by the mode switching part 240 (S460).

If it determines that the received mode switch signal is directed to itself at S450, the tag controlling part 250 controls such that the current mode can be switched into sleep mode by the mode switching part 240. Accordingly, the standby mode of the RFID tag 200 is switched into sleep mode by the mode switching part 240 (S470).

When switched into sleep mode, the RFID tag 200 stands by for a predetermined sleep time (S480), and after the predetermined sleep time, the tag controlling part 250 controls such that the current mode can be switched into normal mode by the mode switching part 240 (S490).

After that, if the reception of the tag data from the RFID reader 100 is not completed, the RFID tag 200 re-receives tag recognition signal from the RFID reader 100 and operation repeats from S400 (S492).

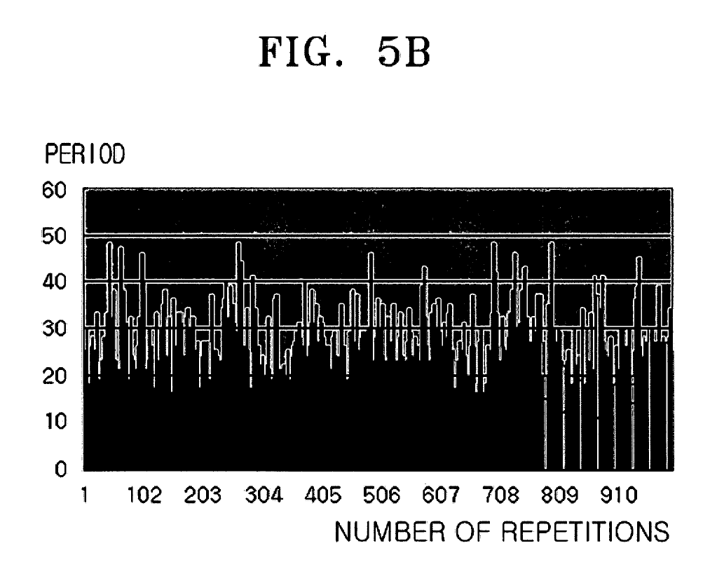

FIGS. 5A and 5B are graphs provided for explaining the time consumption required for the RFID reader to recognize a RFID tag within a predetermined time according to an exemplary embodiment of the present invention.

More specifically, FIGS. 5A and 5B represent graphs of time consumption in an example where the RFID reader 100 reads in a few number of, namely, five (5) RFID tags 200, within a predetermined time, namely, within 1000 repetitions of operation.

FIG. 5A graphically represents time consumption for a RFID reader to read in RFID tags according to a conventional system. In a conventional system, an average of actual time consumption indicates that 20 RFID tags are recognized within 28 periods.

FIG. 5B graphically represents the time consumption for a RFID reader to read in RFID tags according to an exemplary embodiment of the present invention. According to the RFID reader 100 and the RFID tags 200 according to the present invention, 20 RFID tags 200 are recognized within 21 periods.

By comparing FIGS. 5A and 5B, it is proved that RFID reader 100 according to an exemplary embodiment of the present invention can recognize all of the RFID tags 200 in the transmission range approximately 25% faster than the conventional way where a plurality of RFID tags respond each after different random time intervals.

In conclusion, especially for a wireless terminal device with RFID reader 100 attached thereon, which uses a few number of RFID tags 200, for example, 10 RFID tags 200, time consumption can be greatly reduced for the RFID reader 100 to recognize all of the corresponding RFID tags 200.

As described above in a few exemplary embodiments of the present invention, a RFID tag and RFID reader for anti-collision and an operation method thereof can reduce the collision of tag data from a plurality of RFID tags, especially in a device such as a wireless terminal which has a few number of RFID tags attached thereon, and also can read in RFID tags rapidly.

The foregoing embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A radio frequency identification (RFID) tag for anti-collision, comprising:
a tag receiving part that receives a tag recognition signal from a RFID reader;
a tag transmitting part that transmits a response signal and tag data in response to the tag recognition signal;
a mode switching part that switches a current mode into a predetermined mode; and
a controlling part that causes the predetermined mode to be switched by the mode switching part, when the response signal is transmitted a predetermined number of times by the tag transmitting part.

2. The RFID tag of claim 1, wherein the predetermined mode switched by the mode switching part comprises at least one of a normal mode, a standby mode, a sleep mode and a dead mode.

3. The RFID tag of claim 2, wherein the controlling part controls such that the current mode is switched into the standby mode by the mode switching part, when the response signal is transmitted the predetermined number of times.

4. The RFID tag of claim 2, wherein the controlling part controls such that the current mode is switched into the sleep mode by the mode switching part, when a mode switch signal relating to the RFID tag is transmitted from the RFID reader through the tag transmitting part.

5. An operating method of a radio frequency identification (RFID) tag for anti-collision, comprising:
receiving a tag recognition signal from a RFID reader;
transmitting a response signal and tag data in response to the tag recognition signal; and
switching a current mode to a predetermined mode, when the response signal is transmitted a predetermined number of times.

6. The operation method of claim 5, wherein the predetermined mode for switching comprises at least one of a normal mode, a standby mode, a sleep mode and a dead mode.

7. The operation method of claim 6, further comprising switching the current mode into the sleep mode, when a mode switch signal relating to the RFID tag itself is transmitted from the RFID reader.

8. A radio frequency identification (RFID) reader for anti-collision, comprising:
a reader transmitting part that transmits a tag recognition signal to one or more RFID tags;
a reader receiving part that receives tag data from the one or more RFID tags in accordance with the tag recognition signal; and
a controlling part that, when the tag data is received, generates a mode switch signal for a RFID tag corresponding to the received tag data and transmitting through the reader transmitting part.

9. The RFID reader of claim 8, wherein, if the reception of the tag data fails, the controlling part controls such that the tag data is re-received through the reader receiving part.

10. The RFID reader of claim 8, wherein the mode switch signal generated by the controlling part comprises a signal to switch the RFID tag into a sleep mode.

11. The RFID reader of claim 8, wherein the controlling part controls the reader transmitting part to re-transmit the tag recognition signal, after the mode switch signal is transmitted through the reader transmitting part.

12. An operation method of a radio frequency identification (RFID) reader for anti-collision, comprising:
transmitting a tag recognition signal to one or more RFID tags;
receiving tag data from the one or more RFID tags in accordance with the tag recognition signal; and
generating a mode switch signal for a RFID tag corresponding to the received tag data and transmitting the mode switch signal, when the tag data is received.

13. The operation method of claim 12, further comprising re-receiving the tag data if the reception of the tag data fails.

14. The operation method of claim 12, wherein the generated mode switch signal comprises a signal to switch the RFID tag into a sleep mode.

15. The operation method of claim 12, further comprising re-transmitting the tag recognition signal, after the mode switch signal is transmitted.
